(19) United States
(12) Patent Application Publication
(10) Pub. No.: US 2025/0226494 A1
(43) Pub. Date: Jul. 10, 2025

(54) BATTERY CASSETTE

(71) Applicant: AVL Mobility Techologies, Inc., Plymouth, MI (US)

(72) Inventors: Thomas Huettner, Lake Forest, CA (US); Alwin Lutz, Aliso Viejo, CA (US); Mason Miller, Lake Forest, CA (US)

(21) Appl. No.: 19/008,717

(22) Filed: Jan. 3, 2025

Related U.S. Application Data
(60) Provisional application No. 63/617,678, filed on Jan. 4, 2024.

(51) Int. Cl. H01M 50/143; H01M 50/35; H01M 50/569

(52) U.S. Cl. CPC H01M 50/143; H01M 50/35; H01M 50/569

(57) ABSTRACT

A battery cassette for a vehicle comprises a first group of battery cells, a first firewall surrounding the first group of battery cells, a second group of battery cells, and a second firewall surrounding the second group of battery cells, wherein the first firewall and the second firewall separate the first group of battery cells from the second group of battery cells to prevent thermal runaway in one of the first group of battery cells or second group of battery cells from occurring in the other of the first group of battery cells or second group of battery cells.

### CROSS REFERENCE TO RELATED APPLICATIONS

This application claims priority under 35 U.S.C. § 119 (e) to U.S. Provisional Application No. 63/617,678, filed on Jan. 4, 2024. The disclosure of this prior application is considered part of the disclosure of this application and is hereby incorporated by reference in its entirety.

### FIELD

The present disclosure relates generally to a battery cassette for a vehicle.

### BACKGROUND

This section provides background information related to the present disclosure and is not necessarily prior art.

High capacity battery cassettes, such as those implemented in electric vehicles (EVs), aircraft, or home systems are typically composed of a plurality of cells that cooperate to deliver power, such as electrical power to propulsion systems of the EVs or aircraft or electrical systems of a home or business. Due to the power output that is required of these cells, certain complications may arise during operation. For example, the failure of an individual cell or several cells may result in thermal and/or performance issues, such as thermal runaway. Segregating the cells into groups may confine any thermal and/or performance issues to specific cell groups, reducing the risk of the thermal and/or performance issues from proliferating to the entire battery cassette.

### SUMMARY

This section provides a general summary of the disclosure, and is not a comprehensive disclosure of its full scope or all of its features.

One aspect of the disclosure provides a battery cassette for a vehicle comprising a first group of battery cells, a first firewall surrounding the first group of battery cells, a second group of battery cells, and a second firewall surrounding the second group of battery cells, wherein the first firewall and the second firewall separate the first group of battery cells from the second group of battery cells to prevent thermal runaway in one of the first group of battery cells or second group of battery cells from occurring in the other of the first group of battery cells or second group of battery cells.

Implementations of the disclosure may include one or more of the following optional features. In some implementations, the first firewall and the second firewall are formed of a flame resistant material.

The first group of battery cells may be received in a first matrix and the second group of battery cells may be received in a second matrix, the first matrix and the second matrix being formed of a rigid foam material.

The first group of battery cells and second group of battery cells may be arranged in series with each other.

The first group of battery cells and second group of battery cells may be arranged in parallel with each other.

The battery cassette may include a venting mechanism in fluid communication with the first group of battery cells and the second group of battery cells.

The battery cells of the first group and the second group may be lithium-ion batteries.

The battery cassette may be incorporated in an electric vehicle.

The battery cassette may include a first FES board disposed above the first matrix and a second FES board disposed above the second matrix, the first and second FES boards being configured to measure and balance the voltages of the first group of battery cells and the second group of battery cells.

Another aspect of the disclosure provides a battery cassette for a vehicle comprising a first group of battery cells, a first firewall surrounding the first group of battery cells, a first FES board disposed above the first group of battery cells, a second group of battery cells, a second firewall surrounding the second group of battery cells, and a second FES board disposed above the second group of battery cells, the first and second FES boards being configured to measure and balance the voltages of the first group of battery cells and the second group of battery cells, and wherein the first firewall and the second firewall separate the first group of battery cells from the second group of battery cells to prevent thermal runaway in one of the first group of battery cells or second group of battery cells from occurring in the other of the first group of battery cells or second group of battery cells.

Implementations of the disclosure may include one or more of the following optional features. In some implementations, the first firewall and the second firewall are formed of a flame resistant material.

The first group of battery cells may be received in a first matrix and the second group of battery cells may be received in a second matrix, the first matrix and the second matrix being formed of a rigid foam material.

The first group of battery cells and second group of battery cells may be arranged in series or in parallel with each other.

The battery cassette may include a venting mechanism in fluid communication with the first group of battery cells and the second group of battery cells.

The battery cassette may include a first cell cover disposed between the first FES board and the first group of battery cells and a second cell cover disposed between the second FES board and the second group of battery cells. The battery cassette may include plastic clips that connect the first cell cover to the first FES board and the second cell cover to the second FES board.

Another aspect of the disclosure provides a battery cassette for a vehicle comprising a matrix configured to receive a plurality of battery cells, a FES board disposed above the matrix and configured to measure and balance the voltages of the plurality of battery cells, a cell cover disposed between the FES board and the matrix, and one or more plastic clips that connect the FES board to the cell cover.

Implementations of the disclosure may include one or more of the following optional features. In some implementations, the battery cassette includes one or more pogo pins electrically connecting the FES board to one or more of the plurality of battery cells.

The cell cover may include a plurality of apertures and the one or more pogo pins extend through the plurality of apertures.

The matrix may be formed of a rigid foam material

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected configurations and not all possible implementations, and are not intended to limit the scope of the present disclosure.

FIG. 1 is a perspective view of a battery cassette in accordance with principles of the present disclosure;

FIG. 2 is an exploded perspective view of the battery cassette of FIG. 1;

FIG. 3 is a partial cross-sectional view of the battery cassette of FIG. 1, taken along line 3-3 in FIG. 1;

FIG. 4A is a schematic representation of a first exemplary battery cassette having segregated cells in accordance with principles of the present disclosure; and

FIG. 4B is a schematic representation of a second exemplary battery cassette having segregated cells in accordance with principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

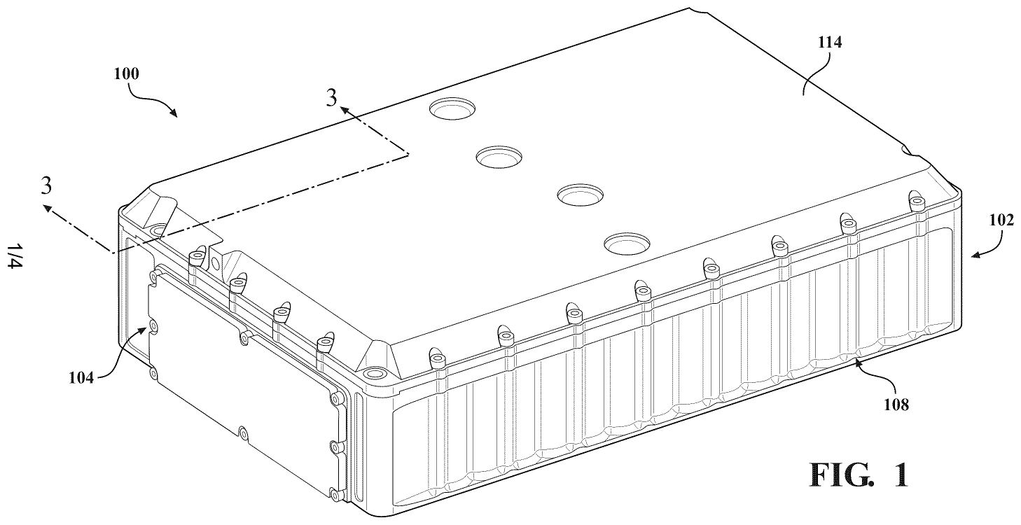

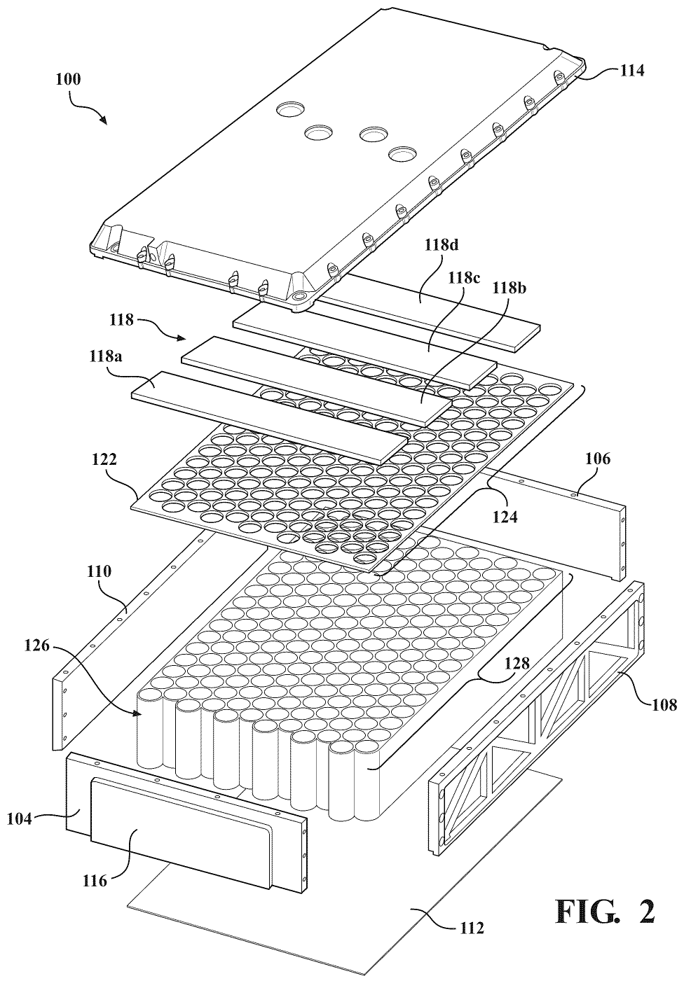

Referring to FIGS. 1 and 2, a battery cassette 100 is generally shown. The battery cassette 100 may be implemented in any suitable vehicle, such as an electric vehicle (EV), including battery electric vehicles (BEVs), plug-in hybrid electric vehicles (PHEVs), and hybrid electric vehicles (HEVs). The battery cassette 100 may also be implemented in any suitable application, such as aerospace applications (e.g., electric aircraft), marine applications (e.g., electric watercraft), residential applications (e.g., home electrical systems), commercial applications (e.g., business electrical systems), etc. In some implementations, the battery cassette 100 is used as the prime energy storage for the aforementioned applications. In other implementations, the battery cassette 100 is used as a secondary (or other backup) energy storage.

The battery cassette 100 includes a housing 102, which may include a front plate 104, a rear plate 106, a first side plate 108, a second side plate 110, a bottom cover 112, and a top cover 114. In other implementations, the housing 102 may be formed of a single, unitary structure. The plates 104, 106, 108, 110 may each be formed of aluminum or any other suitable material, such as aluminum alloys, fiberglass, titanium, magnesium alloys, steel, etc. The plates 104, 106, 108, 110 may be secured to each other in any suitable manner, including via mechanical fasteners (e.g., bolts), welding, etc. The covers 112, 114 may be similarly be secured to each of the plates 104, 106, 108, 110 in any suitable manner, including via mechanical fasteners (e.g., bolts), welding, etc.

The battery cassette 100 includes a FES cover 116, which may be secured to an exterior or interior portion of the front plate 104. In other implementations, the FES cover 116 may be disposed at any suitable location. The FES cover 116 is configured to operate as a controller for the battery cassette 100. In some implementations, the FES cover 116 is configured to operate as a printed circuit board (PCB) controller for the battery cassette 100. For example, the FES cover 116 may transfer controller area network (CAN) messages to the vehicle that the battery cassette 100 is incorporated in. As another example, the FES cover 116 may activate high voltage metal-oxide-semiconductor field-effect transistors (MOSFETs) of the battery cassette 100.

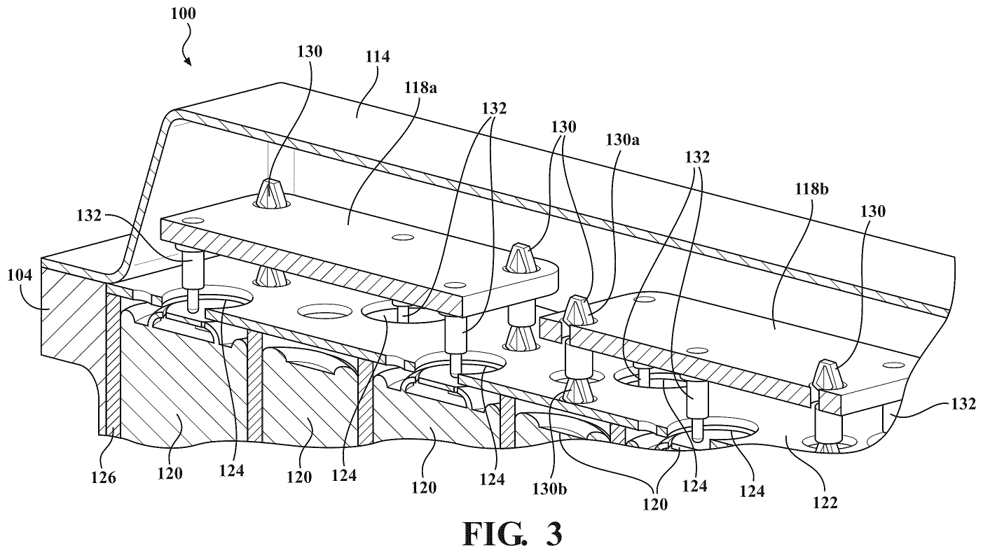

As shown in FIGS. 2 and 3, the battery cassette 100 includes a series of FES boards 118, 118a-d below the top cover 114. The FES boards 118, 118a-d are configured to operate as PCBs that mount battery cells 120 of the battery cassette 100, as described in more detail below. The FES boards 118, 118a-d may measure and balance the voltages and temperatures of the battery cells 120.

With continued reference to FIGS. 2 and 3, the battery cassette 100 includes a cell cover 122 disposed below the FES boards 118, 118a-d. The cell cover 122 includes a plurality of apertures 124 that are aligned with each of the cells 120 below the cell cover 122. The cell cover 122 is configured to protect adjacent cells 120 in a thermal event from conductive hot ejecta, and thus minimize the risk of, or prevent, thermal runaway of the entire battery cassette 100. In some implementations, the cell cover 122 may be formed of FR4, which is a class of PCB base material made from a flame retardant epoxy resin and glass fabric composite. FR stands for flame retardant and meets the requirements of UL94V-0. In other implementations, the cell cover 122 may be formed from laminated mica sheets.

Referring to FIG. 2, the battery cassette 100 includes a matrix 126 defining a plurality of slots 128 that are configured to receive the plurality of battery cells 120. FIG. 2 illustrates the slots 128 without the battery cells 120 for visual clarity. The matrix 126 may be formed of any suitable material, including a rigid foam (e.g., SunForce™×3.5 offered by Asahi Kasei Corp.), ceramic composites, polymer composites, a phase change material, graphite composites, metals, etc. In the case of non-metal materials, the matrix 126 is configured to eliminate the need for individual sleeve wraps (e.g., mica sleeves) in each of the slots 128, thus reducing material costs, assembly time, and weight of the battery cassette 100.

The battery cells 120 may be any suitable shape, including cylindrical, prismatic (e.g., having a rectangular profile), etc., and the slots 128 may include a shape corresponding to the particular shape of the battery cells 120. The battery cells 120 may be any suitable type of battery, including lithium-ion batteries, nickel-metal hydride batteries, lead-acid batteries, ultracapacitors, etc.

Referring to FIG. 3, the FES boards 118, 118a-d include a series of mounting mechanisms, e.g., plastic clips, 130 for mounting the FES boards 118, 118a-d directly to the cells 120 (e.g., through apertures in the cell cover 122) or to the cell cover 122. The plastic clips 130 may include a top snap feature 130a configured snap into the FES boards 118, 118a-d and a bottom snap feature 130b configured to snap into the cell cover 122. The snap features 130a, 130b may include an increasing width that resembles a pyramid shape, triangular shape, or Christmas tree fastener, whereby the snap features 130a, 130b are pressed into apertures of the FES boards 118, 118a-d and the cell cover 122, respectively, until the snap features 130a, 130b pass through the apertures and are secured to the FES boards 118, 118a-d and the cell cover 122, respectively by a catch or lip of the snap features 130a, 130b.

The plastic clips 130 are configured to eliminate retention screws, which reduces assembly time and potential foreign matter in the battery cassette 100, reduce rework time for out of specification voltages or thermistor readings by approximately 15 minutes via elimination of a traditional cover reassembly process, and create an environmental seal allowing the cell cover 122 to be lighter and cheaper to produce.

The FES boards 118, 118a-d include a series of electrical connector mechanisms, e.g., pogo pins or spring-loaded pins, 132 that extend through the apertures 124 of the cell cover 122 to contact each of the battery cells 120. The pogo pins 132 are configured to facilitate measurement and balancing of the voltages of the battery cells 120.

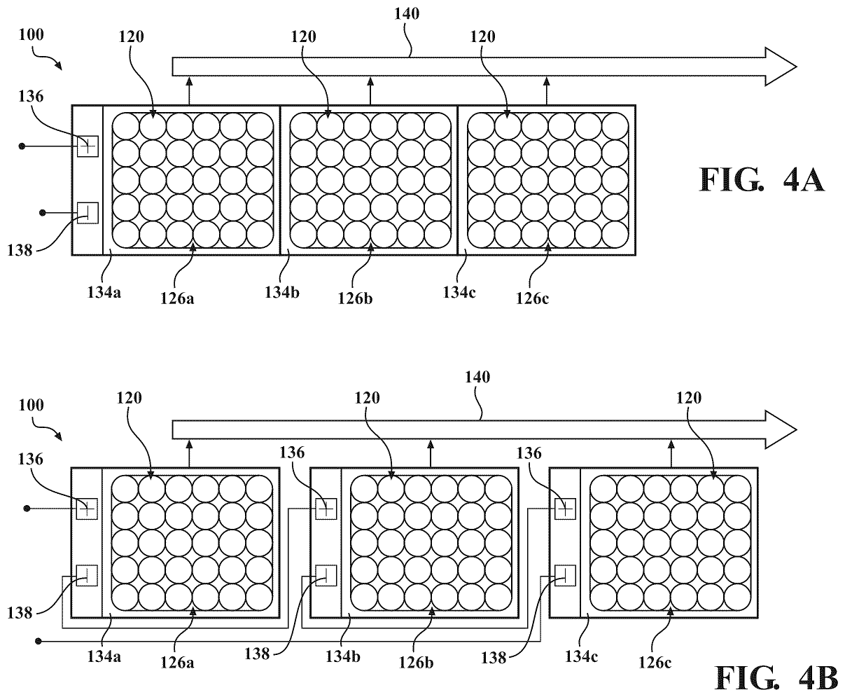

Referring to FIGS. 4A and 4B, the battery cassette 100 may include multiple matrices 126. Three matrices 126a-c are shown for illustrative purposes, however, it should be understood that any suitable number of matrices 126 may be implemented. Additionally, FIGS. 4A and 4B are schematic representations, and it should be understood that the battery cassettes 100 shown and described with respect to FIGS. 4A and 4B may include any or all of the features described above in connection with FIGS. 1-3.

The battery cassette 100 may include a firewall 134, 134a-c surrounding each of the matrices 126, 126a-c. The firewalls 134, 134a-c may be formed of any suitable flame resistant or retardant material, such as a metal (e.g., aluminum), FR4, etc.

The battery cassettes 100 include a positive terminal 136 and a negative terminal 138. Referring to FIG. 4A, the groups of battery cells 120 may be arranged in series with a single positive terminal 136 and a single negative terminal 138 in electrical communication with all of the battery cells 120. Referring to FIG. 4B, the groups of battery cells 120 may be arranged in parallel with a positive terminal 136 and a negative terminal 138 for each group of battery cells 120. The battery cassettes 100 include a venting mechanism 140 in fluid communication with each of the groups of battery cells 120 and configured to vent air out of the groups of battery cells 120. The venting mechanism 140 may be an exhaust pipe or similar mechanism.

The firewalls 134, 134a-c and the discrete matrices 126, 126a-c may segregate groups of battery cells 120 from adjacent groups of battery cells 120. The segregated groups of battery cells 120 may include any suitable number of battery cells 120, e.g., thirty battery cells 120 as shown. In situations where an individual battery cell 120 experiences thermal runaway, it is very difficult, if not impossible, to prevent thermal runaway from occurring in adjacent battery cells 120. However, by segregating battery cells 120 into groups via the firewalls 134, 134a-c and the discrete matrices 126, 126a-c, the battery cassette 100 may prevent thermal runaway in one of the groups of battery cells 120 from occurring in adjacent groups of battery cells 120. If a specific group of battery cells 120 does experience thermal runaway, the battery cassette 100 is configured to permit the group of compromised battery cells 120 to be swapped out with a new, uncompromised group of battery cells 120. Thus, the battery cassette 100 described herein mitigates damage in thermal runaway events and saves costs by confining replacement of battery cells 120 to only specific groups that are affected by thermal runaway, rather than replacement of all the battery cells 120.

In other implementations, the battery cassette 100 shown in FIGS. 4A and 4B may comprise multiple mini-cassettes connected in series to form a conventional cassette unit or string which are then connected in parallel as conventional cassettes. Each mini-cassette contains the maximum number of battery cells 120 that can be managed in a scenario where all the battery cells 120 of the mini-cassette go into thermal runway. As a result, most protective features of a battery cassette may no longer be required. Because all of the battery cells 120 of each mini-cassette are allowed to go into thermal runway, no protective measures are needed anymore and high energy dense cells, pouch cells, or any other suitable cells may be implemented. The safety characteristics of the modular battery cassette 100 shown in FIGS. 4A and 4B are still available and maintained through the segregation of the mini-cassettes via the firewalls 134, 134a-c. The battery cassette 100 of FIGS. 4A and 4B may also incorporate any type of cooling system, such as, for example, liquid cooling, air cooling, indirect cooling, immersed cooling, etc.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cassette for a vehicle comprising:
a first group of battery cells;
a first firewall surrounding the first group of battery cells;
a second group of battery cells; and
a second firewall surrounding the second group of battery cells,
wherein the first firewall and the second firewall separate the first group of battery cells from the second group of battery cells to prevent thermal runaway in one of the first group of battery cells or second group of battery cells from occurring in the other of the first group of battery cells or the second group of battery cells.

2. The battery cassette of claim 1, wherein the first firewall and the second firewall are formed of a flame resistant material.

3. The battery cassette of claim 1, wherein the first group of battery cells are received in a first matrix and the second group of battery cells are received in a second matrix, the first matrix and the second matrix being formed of a rigid foam material.

4. The battery cassette of claim 1, wherein the first group of battery cells and second group of battery cells are arranged in series with each other.

5. The battery cassette of claim 1, wherein the first group of battery cells and second group of battery cells are arranged in parallel with each other.

6. The battery cassette of claim 1, further comprising a venting mechanism in fluid communication with the first group of battery cells and the second group of battery cells.

7. The battery cassette of claim 1, wherein the battery cells of the first group and the second group are lithium-ion batteries.

8. The battery cassette of claim 1, wherein the battery cassette is incorporated in an electric vehicle.

9. The battery cassette of claim 1, further comprising a first FES board disposed above the first group of battery cells and a second FES board disposed above the second group of battery cells, the first and second FES boards being configured to measure and balance the voltages of the first group of battery cells and the second group of battery cells.

10. A battery cassette for a vehicle comprising:
a first group of battery cells;
a first firewall surrounding the first group of battery cells;
a first FES board disposed above the first group of battery cells;
a second group of battery cells;
a second firewall surrounding the second group of battery cells; and
a second FES board disposed above the second group of battery cells, the first and second FES boards being configured to measure and balance the voltages of the first group of battery cells and the second group of battery cells, and
wherein the first firewall and the second firewall separate the first group of battery cells from the second group of battery cells to prevent thermal runaway in one of the first group of battery cells or second group of battery cells from occurring in the other of the first group of battery cells or second group of battery cells.

11. The battery cassette of claim 10, wherein the first firewall and the second firewall are formed of a flame resistant material.

12. The battery cassette of claim 10, wherein the first group of battery cells are received in a first matrix and the second group of battery cells are received in a second matrix, the first matrix and the second matrix being formed of a rigid foam material.

13. The battery cassette of claim 10, wherein the first group of battery cells and second group of battery cells are arranged in series or in parallel with each other.

14. The battery cassette of claim 10, further comprising a venting mechanism in fluid communication with the first group of battery cells and the second group of battery cells.

15. The battery cassette of claim 10, further comprising a first cell cover disposed between the first FES board and the first group of battery cells and a second cell cover disposed between the second FES board and the second group of battery cells.

16. The battery cassette of claim 15, further comprising plastic clips that connect the first cell cover to the first FES board and the second cell cover to the second FES board.

17. A battery cassette for a vehicle comprising:
a matrix configured to receive a plurality of battery cells;
a FES board disposed above the matrix and configured to measure and balance the voltages of the plurality of battery cells;
a cell cover disposed between the FES board and the matrix; and
one or more plastic clips that connect the FES board to the cell cover.

18. The battery cassette of claim 17, further comprising one or more pogo pins electrically connecting the FES board to one or more of the plurality of battery cells.

19. The battery cassette of claim 18, wherein the cell cover includes a plurality of apertures and the one or more pogo pins extend through the plurality of apertures.

20. The battery cassette of claim 17, wherein the matrix is formed of a rigid foam material.
